(19) United States
(12) Patent Application Publication
(10) Pub. No.: US 2022/0383207 A1
(43) Pub. Date: Dec. 1, 2022

(54) System and Method for Automating a Task with a Machine Learning Model

(71) Applicant: BLUEOWL, LLC, San Francisco, CA (US)

(72) Inventor: Kenneth J. Sanchez, San Francisco, CA (US)

(21) Appl. No.: 16/048,615

(22) Filed: Jul. 30, 2018

(51) Int. Cl. G06N 99/00; G06N 5/04

(52) U.S. Cl. CPC G06N 99/005; G06N 5/048; H04W 84/02

(57) ABSTRACT

A system and methods relate to, inter alia, determining a prediction confidence level associated with machine identification of production data based on a machine learning model. The system and methods further relate to routing the production data to at least one of a human analyzer device associated with the human analyzer or a prediction engine of the server based on the prediction confidence level for identification of the data. The machine learning model of the system and methods may be configured to be modifiable in response to feedback from at least one of the human analyzer device or the prediction engine.

### TECHNICAL FIELD

The present disclosure relates generally to automating a task with a machine learning model, and particularly, inter alia, to a system and methods for automating a task according to a machine learning model that is modifiable in response to both human and machine feedback in a production environment.

### BACKGROUND

Computer vision broadly encompasses how computers analyze digital content such as images and videos, with the goal of automating tasks that human visual systems do naturally. Computer vision tasks include methods for acquiring, processing, analyzing, and transforming digital images and videos into information that computers can understand (e.g., numerical or symbolic information) that can interface with electronic processes. Conventionally, the advancement of computer vision is dependent on the availability of a large quantity of data (e.g., training data) that can be used as an input into a computer database where a supervised machine learning model can access and process the training data. However, one of the obstacles in computer vision, and machine learning in general, is that a large quantity of training data is not always available. Some prior solutions include manually creating training data internally within an organization to feed its computer database in a training environment, but creation of such training data is costly and labor-intensive for the organization. In contrast, some prior solutions use web-based applications, such as Amazon's Mechanical Turk, to allow human users external to an organization to complete a specific task related to computer vision, thereby having human users generate training data on the organization's behalf. However, because human users are not necessarily experts in completing the specific task, a machine learning model may not always have “perfect” training data to further its machine learning capabilities, but rather, error-filled training data. For example, a task may be to identify text on an image that is hard to read, and a human user that volunteers to complete the task may misidentify the text. Because conventional computer vision systems that utilize such human involvement focus on a single human user for completing the task, machine learning models may be fed inaccurate data if the single human user does not accurately complete the task. For organizations for example that rely on reliable and accurate machine learning models to process sensitive data, such conventional solutions fall short. Further, in conventional systems, training data may be analyzed in a local training environment that is set up on a software developer's machine, in order to develop machine learning models for the production environment that has a stable build of the machine learning models ready for actual use. Because training data does not always replicate production data, machine learning models may not always be accurate for processing production data.

What is needed is a novel approach for generating highly accurate training data for a machine learning model, as well as taking advantage of production data to formulate and/or train machine learning models. Further, what is also needed is a novel approach for managing task assignments, i.e., reserving tasks that are more difficult for machines to complete, for the human users, and demanding less effort from human users to complete a task as machine learning models gain proficiency.

### BRIEF SUMMARY

The present embodiments disclose systems and methods that may generally relate to automating a task with a machine learning model, and particularly, inter alia, to a system and methods for automating a task according to a machine learning model that is modifiable in response to both human and machine feedback in a production environment.

By receiving production data from actual end users (i.e., clients, customers) operating a client device (e.g., mobile electronic device), a client-serving server configured with a machine learning model and a prediction engine may process the received production data, with the aid of human analyzers, to serve the end users. By working with actual production data as opposed to artificially and manually created training data, such a machine learning model is provided with data that is most similar to the data likely to be encountered in the production environment.

The machine learning model may be developed from one or more computer machine learning algorithms capable of acquiring, processing, analyzing, and transforming (hereinafter collectively referred to “identifying” or “identification”) production data into information that computers can understand (e.g., numerical or symbolic information) that can interface with electronic processes. Depending on the prediction confidence level associated with machine identification of the production data based on the machine learning model, the production data may be routed to a client-serving human analyzer device, a prediction engine of the client-serving server, or both. For example, if the prediction confidence level indicates that the machine learning model is not proficient in identifying a certain production data, routing the production data to the client-serving human analyzer device allows one or more human analyzers to use his or her human visual system to identify the data, where such human-identification may serve as feedback and/or a benchmark for the machine learning model and the prediction engine to further its prediction capabilities. Further, depending on the prediction confidence level, the one or more human analyzer may be asked to identify the data at various levels of abstraction, such as complete identification (e.g., request the human analyzer to read text in an image and enter in the text into the human analyzer device) or mere confirmation identification (e.g., request the human analyzer to confirm that a machine-predicted text matches the text that appears in an image). Further, by allowing more than one human analyzer to identify the data, the likelihood of human-error when identifying the data may be substantially reduced. If the prediction confidence level indicates that the machine learning model is proficient in identifying a certain production data, the server may directly route the data to the prediction engine for machine-identification, bypassing the human analyzer device entirely.

Accordingly, in some embodiments, a system and methods may receive, via wireless communication or data transmission over one or more radio links or digital communication channels, data from a client device. The system and methods may further determine a prediction confidence level associated with machine identification of the data based on a machine learning model. The system and methods may further route the data to at least one of a human analyzer device associated with a human analyzer or a prediction engine of the server based on the prediction confidence level for identification of the data. The machine learning model may be configured to be modifiable in response to feedback from at least one of the human analyzer device or the prediction engine.

In some embodiments, an interconnected wireless communication system may include a processor, transceiver, sensors and one or more memory devices storing non-transitory computer readable instructions that when executed cause the processor to receive, via wireless communication or data transmission over one or more radio links or digital communication channels, data from a client device. The instructions may further cause the processor to determine a prediction confidence level associated with machine identification of the data based on a machine learning model. The instructions may further cause the processor to route the data to at least one of a human analyzer device associated with a human analyzer or a prediction engine of the server based on the prediction confidence level for identification of the data.

Advantages will become more apparent to those skilled in the art from the following description of the preferred embodiments which have been shown and described by way of illustration. The combination of machine learning with feedback control with production data from client devices enables the present system and methods to achieve exceptionally high accuracy of automation efficiently and cost-effectively. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

There are shown in the drawings arrangements which are presently discussed, it being understood, however, that the present embodiments are not limited to the precise arrangements and instrumentalities shown, wherein:

FIG. 1 illustrates an exemplary block diagram of an exemplary interconnected wireless communication system on which the methods described herein may be implemented according to some embodiments;

FIG. 2 illustrates an exemplary block diagram of an exemplary server according to some embodiments;

FIG. 3 illustrates an exemplary block diagram of an exemplary engine according to some embodiments;

FIG. 4 illustrates an exemplary block diagram of an exemplary server according to some embodiments;

FIG. 5 illustrates an exemplary method for automating a task with a machine learning model according to some embodiments;

FIG. 6 illustrates an exemplary method for automating a task with a machine learning model according to some embodiments;

FIG. 7 illustrates an exemplary user interface according to some embodiments.

### DETAILED DESCRIPTION

The present embodiments may generally relate to a system and methods for automating a task with a machine learning model, and particularly, inter alia, to a system and methods for automating a task according to a machine learning model that is modifiable in response to both human and machine feedback.

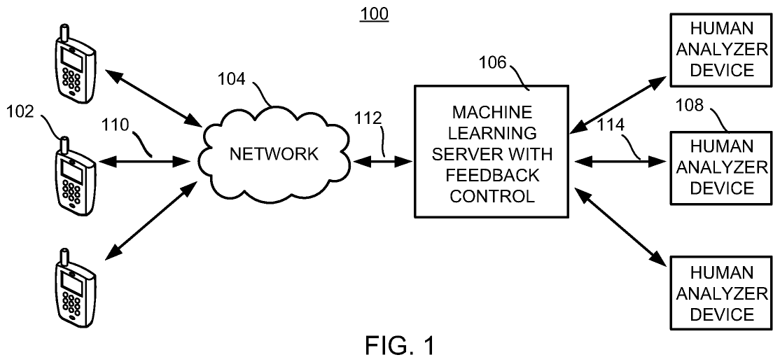

FIG. 1 illustrates a block diagram of an interconnected wireless communication system 100 in accordance with some embodiments on which the methods described herein may be implemented. The communication system 100 may generally be divided into front-end components and back-end components, both of which may include hardware and software applications, as well as various data communications channels for communicating data between the various hardware and software components. The front-end components may include a client device 102, such as a mobile device (e.g., a smart phone, a cellular phone, a tablet computer, a special purpose or general use computing device, smart watch, wearable electronics such as augmented reality appliance, and the likes). The front-end components may record data (i.e., production data) from a sensor (e.g., a camera) or generate its own data (i.e., production data), and the back-end components may provide processing of such data. The data that is generated or recorded and later processed may be in the form of text data, image data, mobile device data, sensor data, or other production data suitable as inputs for machine learning models. For example, a customer of an insurance company may be providing an image of his driver's license taken by a camera on his mobile device for processing by the insurance company's back-end components, such as processing servers. The sensors may also be removably or fixedly incorporated within or connected to the client device 102 and may be disposed in various arrangements. In various embodiments, the client device 102 may be configured to execute one or more algorithms, programs, or applications to generate or record data from one or more sensors. For example, client device 102 may utilize a camera to capture an image of an object.

In some embodiments, the client device 102 may be configured to store the data and/or send the data to back-end components, such as the server 106 and human analyzer device 108, via a network 104, and the server 106 may be configured to receive the data that was generated or recorded by the client device 102. The client device 102 may be configured to send and/or receive data from network 104 using one or more suitable communication protocols, such as a Wi-Fi direct protocol, an ad-hoc cellular communication protocol, and the likes. Network 104 may be a proprietary network, a secure public internet, a virtual private network or some other type of network, such as dedicated access lines, plain ordinary telephone lines, satellite links, cellular data networks, or a combination thereof. Network 104 may be implemented as a wireless telephony network (e.g., GSM, CDMA, LTE, etc.), a Wi-Fi network (e.g., via one or more IEEE 802.11 Standards), a WiMAX network, a Bluetooth network, and the likes. The network 104 may include one or more radio frequency communication links, such as wireless communication links 110 and 112 to communicate with the client device 102 and server 106, respectively. The network 104 may comprises the Internet, and data communications may take place over the network 104 via an Internet communication protocol.

The server 106 may be further configured to transmit the data received from the client device 102 to the human analyzer device 108. The human analyzer device 108 may be a mobile device (e.g., a smart phone, a cellular phone, a tablet computer, a special purpose or general use computing device, smart watch, wearable electronics such as augmented reality appliance, and the likes), a stationary device (e.g., desktop computer), a server, or any other suitable electronic device having a user interface configured to receive human input. In a preferred embodiment, the human analyzer device 108 is affiliated with the server 106 and provides an interface for a human analyzer to identify data received from the client device 102. The human analyzer device 108 may be owned by, operated by, and/or otherwise associated with the human analyzer. The human analyzer may include any individual or group of individuals that seeks to identify data received from the client device 102 using his or her human visual system. For example, if a customer of an insurance company provides an image of his driver's license for processing by the insurance company's back-end components, an employee of the insurance company may use the human analyzer device 108 to identify the image as the customer's driver's license, and to transmit the identified data to the server 106. The employee, as the human analyzer, may have the expertise required to identify and process the data provided by the front-end components.

In preferred embodiments, the server 106 may be a machine learning server (i.e., server that is trained using supervised or unsupervised machine learning) configured to receive feedback to improve its machine learning model. The machine learning model may be developed to allow parametric or nonparametric statistical analysis of large quantities of data. The machine learning model may be used to automatically identify relevant variables (i.e., variables having statistical significance or a sufficient degree of explanatory power) from data that was generated or recorded by the client device 102. This may include identifying relevant variables or estimating the effect of such variables that indicate actual observations in the data. This may also include identifying latent variables not directly observed in the data, viz. variables inferred from the observed data. In some embodiments, the machine learning model described herein may be developed by algorithm(s) to identify and estimate the effects of observed or latent information. The machine learning model may employ a neural network, which may be a convolutional neural network, a deep learning neural network, or a combined learning model or program that learns in two or more fields or areas of interest. Machine learning may involve identifying and recognizing patterns in existing data in order to facilitate making predictions. Models may be created based upon example inputs of data in order to make valid and reliable predictions for novel inputs.

Additionally or alternatively, the machine learning model may be trained by inputting sample data sets or certain data into algorithm(s), such as client inputs and data from the sensors discussed herein. The machine learning model may be developed by deep learning algorithm(s) that are primarily focused on pattern recognition, and may be trained after processing multiple examples. The learning algorithm(s) themselves may also be improved, thereby leading to improved machine learning models. A plurality of learning algorithms may be cycled through to test different hyper parameters of different machine learning models in order to find the best learning model or models. Different models may work better for different inputting sample data sets or certain data. The machine learning model may include Bayesian program learning (BPL), voice recognition and synthesis, image or object recognition, optical character recognition, and/or natural language processing—either individually or in combination. The machine learning model may also include natural language processing, semantic analysis, automatic reasoning, and/or machine learning.

In supervised machine learning, the server 106 may be provided with example inputs and their associated outputs, and may seek to discover and/or train a machine learning model that maps inputs to outputs, so that when subsequent novel inputs are provided the processing element may, based upon the discovered or trained machine learning model, accurately predicts the correct or a preferred output. The training process for the machine learning model continues until the model achieves a desired level of accuracy on subsequent novel inputs. Example algorithms used to discover and train such supervised models include logistic regression and back propagation neural network. In unsupervised machine learning, the server 106 may be required to find its own structure in unlabeled example inputs to prepare a machine learning model. In one embodiment, machine learning techniques may be used to extract the control signals generated by computer systems or sensors, and under what conditions those control signals were generated. Example algorithms used to discover and train unsupervised machine learning models include the Apriori algorithm and k-Means.

After training with initial data from the client device, the machine learning model (or information generated by such machine learning model) may be used to evaluate additional data from the same client device 102 or other client devices 102. Such data may be related to past data already gathered by the server 106. The trained machine learning model may then be used for determining, assessing, analyzing, predicting, estimating, evaluating, or otherwise processing new data not included in the initial data. Such new or additional data may be related to current, up-to-date, or real-time data gathered by the sensors, or other similar data to be analyzed or processed. Such a trained machine learning model may, thus, be used to perform part or all of the analytical functions of the methods described elsewhere herein.

Server 106 may aggregate the data received from the front-end components 102 via the network 104, store the data, process the data, and/or communicate information associated with the data or the data itself back to the client device 102. Further, the server 106 may access data stored in memory when executing various functions and tasks associated with automating a task according to a machine learning model that is modifiable in response to both human and machine feedback. Server 106 is configured to store information associated with the data. For example, information associated with each driving activity includes an identifier associated with the user that performed the driving activity, the date and/or period of time during which the driving activity took place, the device type that was used to record the driving activity data, and the vehicle used by the user during the driving activity. In some embodiments, the information associated with each driving activity is stored by server 106 in a searchable driving activity table 140 that comprises a SQL-based data table. Server 106 is configured to store the set of geolocation data and/or a corresponding auxiliary data associated with (e.g., recorded geolocation data point along) each driving activity.

Although the system 100 is shown to include one client device 102, one server 106, and one human analyzer device 108, it should be understood that additional mobile devices 102, servers 106, and human analyzer devices 108 may be utilized. For example, the system 100 may include a call center comprising hundreds of human analyzer devices 108, all of which may be interconnected via the network 104. The call center may be staffed to identify data received from numerous mobile devices 102. As another example, the system 100 may include several servers 106, each server 106 dedicated for a particular functionality, such as receiving data from mobile devices 102, determining prediction confidence levels associated with machine identification of the received data based on a machine learning model, and routing such data to a destination based on the prediction confidence level for identification of the data. Furthermore, the processing performed by the one or more servers 106 may be distributed among a plurality of servers 106 in a cloud computing arrangement. This configuration may provide various advantages, such as enabling near real-time uploads and downloads of data, as well as periodic uploads and downloads of data. This may in turn support a thin-client embodiment of the client device 102 discussed herein.

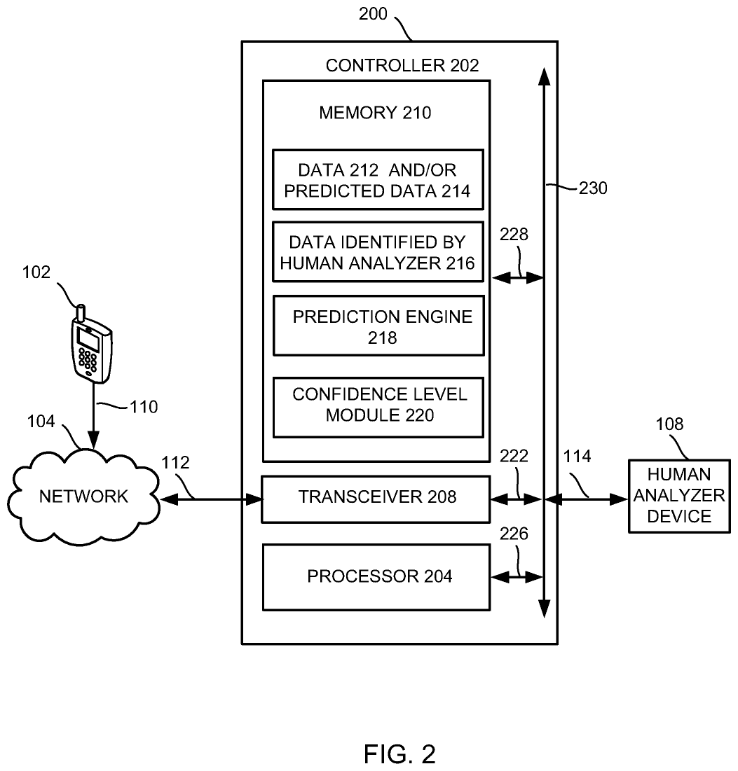

FIG. 2 is a diagram showing an example of a server 200 in accordance with some embodiments. In some embodiments, server 106 of system 100 of FIG. 1 may be implemented with the example server 200 of FIG. 2. The server 200 may comprise a controller 202 that is operatively connected to the network 104 and human analyzer device 108 via wireless communication or data transmission over one or more radio links or digital communication channels 112 and 114, respectively. The controller 202 may include a memory 210, a processor 204, and a transceiver 208, all of which may be interconnected via an address/data bus 230. Specifically, transceiver 208 may interface with the processor 204 and communicate, via link 222, to the network 104 and any device communicatively coupled to the network 104, such as client device 102. The memory 210 of the controller 202 may include one or more RAMs and one or more program memories. The RAM and program memory, communicatively coupled to the address/data bus 230 via link 228 may be implemented as semiconductor memories, magnetically readable memories, or optically readable memories, for example. The memory 210, specifically program memory, may store various engines and modules, which may include a prediction engine 218 and confidence level module 220. In addition, memory 210, specifically RAM, may store data, such as data 212, data 214, and/or data 216. The various engines and modules may be executed by the same computer processor 204 or by different computer processors. Prediction engine 218 and confidence level module 220 may be implemented, for example, as distinct or integrated software components, which can include module(s), package(s), and/or other sub-components to provide an executable computer program that can perform these described functions when executed on a processor, and can be implemented using a programming language such as C, C++, Java, Objective C, and/or other programming languages. The processor 204 may have designated processing cores, and each core can be implemented, for example, as distinct or integrated processing units that read and execute program instructions, such as prediction engine 218 and confidence level module 220, via link 226. The processor 204 may receive data 212 from client device 102 via transceiver 208, store the data 212 in memory 210, process the data 212 using either or both the prediction engine 218 and confidence level module 220, and store the processed data (e.g., as prediction data 214).

In a preferred embodiment, the processor 204 executes confidence level module 220 to determine a prediction confidence level associated with machine identification of the data 212 based on a machine learning model. Generally, the prediction confidence level is a quantization of an evaluation for the machine learning model, which may be developed by machine learning algorithms. Once a task (e.g., identification of data) that needs to be automated and production data, if available, are both defined, machine learning algorithm(s) can be applied to the production data to perform the task. Several weighted or non-weighted factors may contribute towards a prediction score of the machine learning model, such as availability and volume of production data and evaluation data to test machine learning algorithm(s) against, and performance metrics to assess the machine learning algorithm's accuracy in predicting, such as regression, classification, and clustering. The confidence level module 220 may be configured to calculate a prediction confidence level using a suitable mathematical relationship of the aforementioned factors. For ease of illustration, the prediction confidence level described hereinafter will be labeled as “low prediction confidence level,” “average prediction confidence level,” and “high prediction confidence level” to signify three distinct gradations of the prediction score for the machine learning model associated with low prediction accuracy, average prediction accuracy, and high prediction accuracy, respectively. A low prediction confidence level may be indicative of a machine learning model that has access to a relatively low volume of production data and evaluation data, and/or a machine learning model that produces inaccurate predictions when measured against a certain benchmark (e.g., human-identified data), whereas a high prediction confidence level may be indicative of a machine learning model that has access to a relatively large volume of production data and evaluation data and/or a machine learning model that produces accurate predictions when measured against a certain benchmark (e.g., human-identified data). The machine learning model may continue to improve its prediction score, and thus may be able to provide higher prediction confidence levels associated with machine identification of data 212. Accordingly, the processor 204 may be configured to assess the prediction confidence level upon receiving data 212.

If the prediction confidence level is low, the processor 204 may route the data 212 to the human analyzer device 108 for human identification via links 226 and 114. As such, the identified data 216 may be used to formulate the machine learning model if one does not exist, or further train the machine learning model if one does exist. The identified data 216 may also serve as feedback data for modifying the machine learning model to further its prediction capabilities. The identified data 216 may be stored in memory 210.

If the prediction confidence level is average, the processor 204 may route the data 212 to prediction engine 218 via links 226 and 228 and to the human analyzer device 108 for human identification via links 226 and 114. As such, the predicted data 214 generated by the prediction engine 218 may serve as training data for the machine learning model, and the human analyzer device 108 may identify the data as data 216, which may serve as evaluation data. Both data 214 and 216 may be provided to the machine learning model to further its prediction capabilities. The training data and/or evaluation data may also serve as feedback data for modifying the machine learning model to further its prediction capabilities.

If the prediction confidence level is high, it may not be necessary for the human analyzer device 108 to identify data 212. Hence, the processor 204 may route the data 212 directly to the prediction engine 218, thereby bypassing the human analyzer device 108, to generate predicted data 214.

In some embodiments, one or more portions of the server 200 may be implemented as one or more storage devices that are physically co-located with server 200, or as one or more storage devices utilizing different storage locations as a shared database structure (e.g., cloud storage). In some embodiments, client device 102 may be configured to perform any suitable portion of the processing functions locally that have been remotely outsourced from server 200. For example, client device 102 may determining a prediction confidence level associated with machine identification of its own data based on a machine learning model stored in the client device 102. The client device 102 may further route the data to the human analyzer device 108 and/or prediction engine of the server 200 based on the prediction confidence level for identification of the data.

In some embodiments, the server 106 may be part of a customer-centric computing system (or facilitate communications with a computer system), and as such, may access various databases as needed to perform customer service-related functions. Accordingly, data received from mobile device may include user credentials, which may be verified by server 200 or one or more other external computing devices or servers. These user credentials may be associated with a personal profile, which may include, for example, financial account information, insurance policy numbers, a description and/or listing of insured assets, vehicle identification numbers of insured vehicles, addresses of insured users, contact information, driver's license information, and other suitable personal identification information. In this way, data received from client device 102 may allow server 200 to uniquely identify each customer. In addition, server 200 may facilitate the communication of information to their customers for their review, modification, and/or approval.

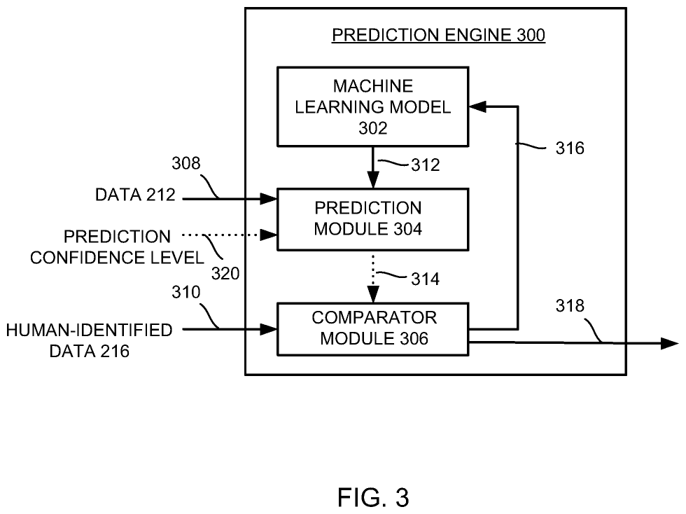

FIG. 3 is a diagram showing an example of the prediction engine 300 in accordance with some embodiments. In some embodiments, prediction engine 218 of server 200 of FIG. 2 may be implemented with the example prediction engine 300 of FIG. 3. As shown in FIG. 3, the prediction engine 300 includes a machine learning model 302, a prediction module 304, and a comparator module 306. The prediction module 304 may, based on utilizing the machine learning model 302 via link 312, predict (e.g., identify) data 212 received via communication link 308. Depending on the prediction confidence level received from the confidence level module 220 via link 320, the prediction module 304 may send the predicted (e.g., identified) data 214 to different targets.

If the prediction confidence level is low or average, the prediction module 304 may send the predicted (e.g., identified) data 214 to the comparator module 306 via link 314. The comparator module may receive human-identified data 216 and accordingly compare the predicted data 214 with the data 216 that has been human-identified by the human analyzer device 108. The results of the comparison may serve as both feedback 316 that is transmitted to the machine learning model 302 to further its prediction capabilities via link 316 and may also serve as an input to the confidence level module 220 via link 318 to keep track of the prediction confidence level associated with the machine learning model 302.

If the prediction confidence level is high, the prediction module 304 need not send the predicted (e.g., identified) data 214 to the comparator module 306 because the processor 204 may have routed the data 212 directly to the prediction engine 218, thereby bypassing the human analyzer device 108 for human-identification of the data 212, to generate predicted data 214. Accordingly, because a corresponding data 216 that has been human-identified by the human analyzer device 108 does not exist for the predicted data 214, the processor 204 may send the predicted data 214 instead to either the client device 102, store the predicted data 214 in memory 210, or both. Therefore, the processor 204, among other tasks, has two primary tasks. The processor 204 is configured to, based on reading the prediction confidence level from the confidence level module 220, route data 212 to either the human analyzer device, or to route data 212 to the prediction engine of the server, thereby bypassing routing the data 212 to the human analyzer device. Second, the processor 204 is further configured to, based on reading the prediction confidence level from the confidence level module 220,

The confidence level module 220 may track the results of the comparison, to generate various prediction confidence levels associated with the machine learning model 302 of the prediction engine 300. The confidence level module 220 may be configured as a cost function to return a number representing how well the machine learning module 302 performed to map data 212 to correct output data 216. For example, for correct predictions, the cost function may increase the number, whereas for incorrect predictions, the cost function may decrease the number. Processor 204 of FIG. 2 may receive the various generated prediction confidence levels from the confidence level module 220 via links 228 and 226 to determine whether to route data 212 directly to the prediction engine 218, thereby bypassing the human analyzer device 108, to generate predicted data 214, and/or route data 212 to the human analyzer device 108.

The machine learning model 302 may be a specialized model for computer vision or image recognition prediction, for example. In such a case, the prediction module 304 of the prediction engine 300 may receive data 212, such as an image. For instance, the image, captured by client device 102 using a camera, may be of a driver's license number or VIN number of a vehicle that needs to be identified electronically and stored in a database of an insurance server. After the prediction module 304 of the prediction engine 300 receives the image from the processor 204, the prediction module 304 may utilize machine learning model 302 to identify the image, such as recognize the driver's license number of “N029421” in the image. The prediction module 304 may send the predicted data 214 (e.g., “N028421”) to the comparator module 306. The comparator module 306 may compare predicted data 214 (e.g., “N028421”) with data 216 (e.g., “N029421”) that has been identified by the human analyzer device 108. For instance, the processor 204 may have routed the data 212 to the human analyzer device 108 after receiving a prediction confidence level of low or average from the confidence level module 220, in order for the human analyzer device 108 to output data 216. Here, the comparator module 306 may determine that the predicted data 214 is incorrect by one character (e.g., “8” should have been identified as a “9”). Accordingly, the comparator module 306 may provide feedback 316 concerning the incorrect identification to the machine learning module 302. Had the predicted data 214 been identical to data 216 (e.g., “N029421”), the comparator module 306 may either provide feedback 316 concerning correct identification to the machine learning module 302, or no feedback at all. The comparator module 306 may also provide the results of the comparison to the confidence level module 220 for the confidence level module 220 to keep track of the confidence level of the machine learning model 302. As the comparator module 306 sends more results that represent correct predictions, the confidence level module 220 will determine higher confidence levels for the machine learning model 302.

In preferred embodiments, it is presumed that the human analyzer using the human analyzer device 108 perfectly identifies data. For example, a human analyzer that views an image having the driver's license number of “N029421” will correctly input the driver's license number of “N029421” into the human analyzer device 108. However, in some embodiments, the server may be configured with a distinct supervisory module that checks the accuracy of human-identification. For example, the supervisory module may require two or more human analyzer devices 108 to identify data 212, and if the identification from the two or more human analyzer devices 108 are identical, only then may the comparator module 306 receive the data 216 correctly analyzed by the human analyzer devices 108.

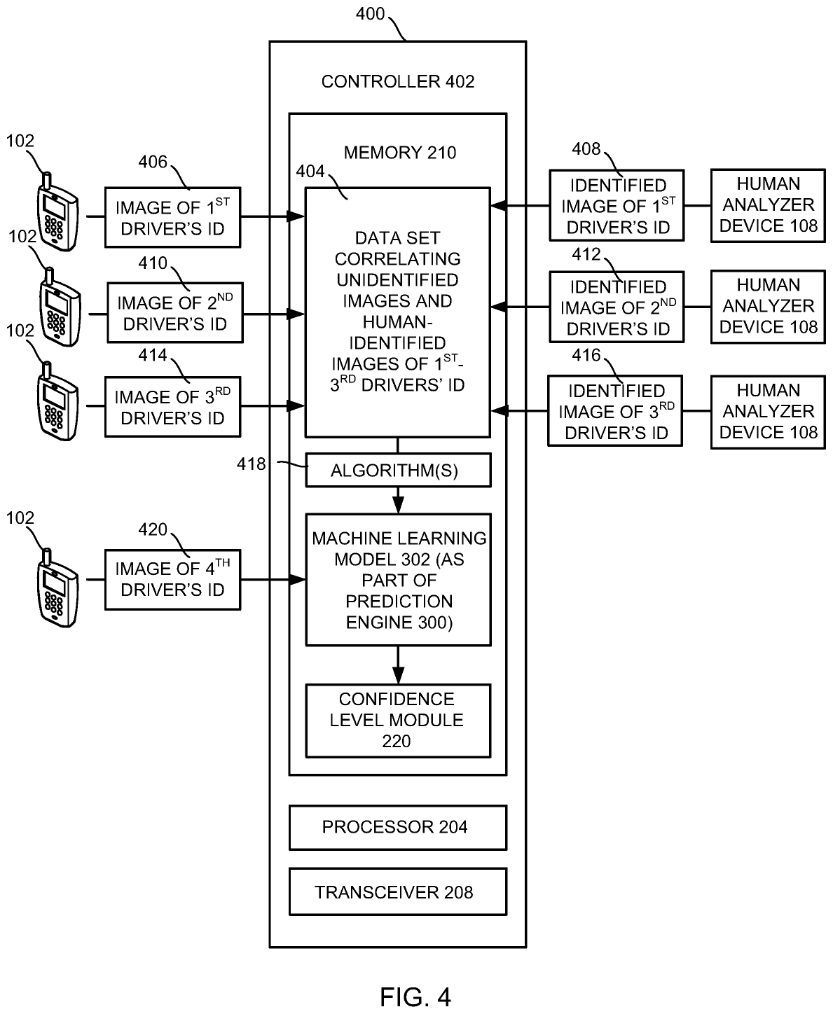

FIG. 4 is a diagram showing an example of a server 400 in accordance with some embodiments. In some embodiments, server 106 of system 100 of FIG. 1 may be implemented with the example server 400 of FIG. 4. Similar to the server 200 of FIG. 2, the server 400 may comprise a controller 402 that is operatively connected to a plurality of client devices 102 via a network (not pictured) and a plurality of human analyzer devices 108 via wireless communication or data transmission over one or more radio links or digital communication channels. The controller 402 may include a memory 210, a processor 204, and transceiver 208, all of which may be interconnected via an address/data bus (not pictured). Specifically, transceiver 208 may interface with the processor 204 and communicate to the network and any device communicatively coupled to the network 104, such as client devices 102. The memory 210 may store a data set 404, algorithm(s) 418, machine learning model 302, and the confidence level module 220. The confidence level module 220 may be executed by the same computer processor 204 or by different computer processors.

In the context of computer vision, the processor 204 may receive three distinct images of three different driver's licenses—image 406, image 410, and image 414, from the same or different client devices 102, and store the images in memory 210. The processor 204 may also route the images to the same or different human analyzers devices 108 for the human analyzers 108 to identify such information as identification number, name, place of birth, date of birth, citizenship, blood type, etc., associated with the images of the drivers' licenses. Upon receiving the identified images 408, 412, and 416 corresponding to images 406, 410, and 414, respectively, the processor 204 may store the pairings as a data set 404 in memory 210. As such, the data set 404 may correlate unidentified images 406, 410, 414 with human-identified images 408, 412, 416. Subsequently, using the data set 404, one or more algorithms stored in memory 210 may develop a machine learning model 302 that can be used to predict (e.g., machine-identify) additional data similar to images 406, 410, and 414, such as image 420 of another driver's license. In other words, data set 404 comprising production data (e.g., image 406, image 410, and image 414) received from the same or different client devices 102 may act as training data to develop machine learning model 302. Therefore, client-serving server 400 may advantageously utilize production data that has been captured by front-end devices (such as by clients), instead of having back-end efforts of manually capturing images, to generate training data to develop machine learning model 302. The machine learning model 302 may be able to identify image 420, and the processor 204 may store image 420 in memory 210 and/or transmit the image 420 to the client device 102 via transceiver 208.

The processor 204 may be configured to execute confidence level module 220 to determine a prediction confidence level associated with machine identification of the images 406, 410, and 414 based on the prediction accuracy of machine learning model 302. For example, if images 406, 410, and 414 are the first images the algorithm(s) 418 has ever processed, the machine learning model 302 may be associated with a low or at best, average prediction confidence level, which means that upon comparing images 406, 410, and 414 and images 408, 412, and 416, several discrepancies were identified. In such a case, the processor 204 may route image 420 to the human analyzer device 108 for human identification, and human-identified image 420 may be paired with the prediction of image 420 as determined by the prediction engine 300 in data set 404 to either modify the algorithm(s) 418 for improved accuracy or at the very least provide additional data for the algorithm(s) 418 to further develop the accuracy of the machine learning model 302. Specifically, the prediction module (not pictured) of the prediction engine 300 may send the prediction of image 420 to the comparator module (not pictured) of the prediction engine 300. The comparator module may receive human-identified image 420 and accordingly compare the prediction of image 420 with the human-identified image 420. The results of the comparison may serve as both feedback that is transmitted to the machine learning model 302 to further its prediction capabilities and may also serve as an input to the confidence level module 220 to keep track of the prediction confidence level associated with the machine learning model 302.

On the other hand, if images 406, 410, and 414 are the 1000^{th}, 1001^{st}, and 1002^{nd} images the algorithm(s) 418 has ever processed for example, the machine learning model 302 may be associated with a high prediction confidence level, which means that upon comparing images 406, 410, and 414 and images 408, 412, and 416, few or no discrepancies were identified. In such a case, for identification of image 420, it may not be necessary for the human analyzer device 108 to identify image 420, as the server 400 may rely on prediction engine 300 to identify the image 420. Hence, the processor 204 may route the image 420 directly to the prediction engine 300, thereby bypassing the human analyzer device 108, to predict (e.g., identify) image 420. Specifically, the prediction module (not pictured) of prediction engine 300 need not send the predicted (e.g., identified) image 420 to the comparator module (not pictured) of the prediction engine 300 because the processor 204 may have routed the image 420 directly to the prediction engine 300, thereby bypassing the human analyzer device 108 for human-identification of the image 420, to generate predicted (e.g., identified) image 420. Accordingly, because a human-identified image 420 that has been human-identified by the human analyzer device 108 does not exist for the predicted (e.g., identified) image 420, the processor 204 may send the predicted (e.g., identified) image 420 instead to either the client device 102, store the predicted (e.g., identified) image 420 in memory 210, or both.

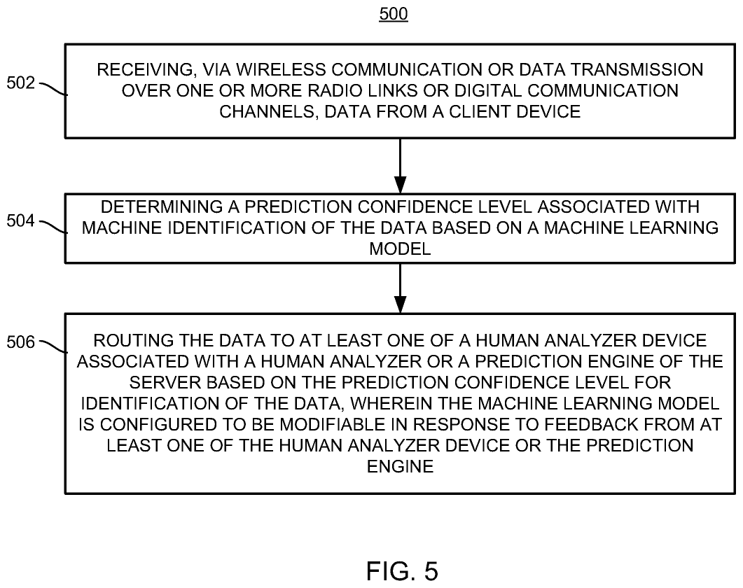

FIG. 5 is an exemplary method 500 for automating a task with a machine learning model in accordance with some embodiments. As shown in FIG. 5, method 500, carried out by the server 200 for example, may begin by receiving, via wireless communication or data transmission over one or more radio links or digital communication channels, data (e.g., data 212) from a client device (e.g., client device 102), as shown in block 502. Method 500 may proceed by determining a prediction confidence level associated with machine identification of the data based on a machine learning model (e.g., machine learning model 302), as shown in block 504. For example, the prediction confidence level may be low, average, or high. Method 500 may proceed by routing the data to a human analyzer device (e.g., human analyzer device 108) associated with a human analyzer, a prediction engine (e.g., prediction engine 218) of the server based on the prediction confidence level for identification of the data, or both, as shown in block 506. For example, if the prediction confidence level for identification of the data is low, method 500 may route the data to the human analyzer device and not the prediction engine. If the prediction confidence level for identification of the data is average, method 500 may route the data to both the human analyzer device and the prediction engine. If the prediction confidence level for identification of the data is high, method 500 may route the data to the prediction engine, bypassing the human analyzer device. The machine learning model is configured to be modifiable in response to feedback associated with the human analyzer device, the prediction engine, or both.

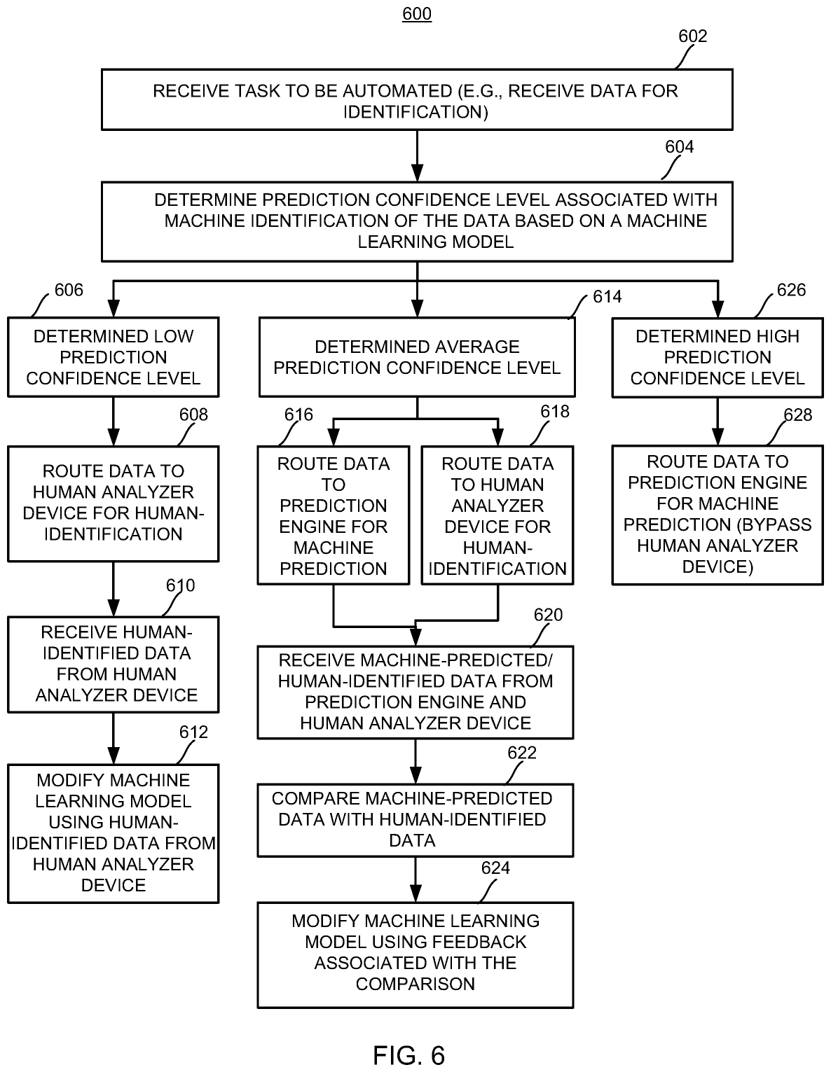

FIG. 6 illustrates an exemplary method 600 for automating a task with a machine learning model according to some embodiments. As shown in FIG. 6, method 600, carried out by the server 200 for example, may begin by receiving a task to be automated (e.g., receiving data 212 for identification), as shown in block 602. Method 600 may proceed by determining a confidence level associated with the machine identification of the data (e.g., data 212) based on a machine learning model, as shown in block 604.

If the prediction confidence level is determined to be low as shown in block 606 (e.g., as determined by the confidence level module 220), the method 600 may proceed by routing (e.g., by the processor 204) the data (e.g., data 212) to a human analyzer device (e.g., the human analyzer device 108) for human identification (e.g., via links 226 and 114), as shown in block 608. The method 600 may proceed by receiving identified data from the human analyzer device, as shown in block 610. The method 600 may proceed by modifying a machine learning model (e.g., machine learning model 302) using the identified data from the human analyzer device (e.g., human analyzer device 108), as shown in block 612.

If the prediction confidence level is determined to be average as shown in block 614 (e.g., as determined by the confidence level module 220), the method 600 may proceed by routing (e.g., by the processor 204) the data (e.g., data 212) to both a prediction engine (e.g., prediction engine 218) for machine prediction, as shown in block 616, and to the human analyzer device (e.g., human analyzer device 108) for human-identification, as shown in block 618 (e.g., via links 226 and 228). The method 600 may proceed by receiving both machine-predicted data (e.g., data 214) and human-identified data (e.g., data 216) from the prediction engine (e.g., prediction engine 218) and human analyzer device (e.g., human analyzer device 108) respectively, as shown in block 620. The method 600 may proceed by comparing (e.g., by the comparator module 306) the machine-predicted data with the human-identified data, as shown in block 622. The method 600 may proceed by modifying the machine learning model (e.g., machine learning model 302) using feedback (e.g., feedback 316) associated with the comparison, as shown in block 624.

If the prediction confidence level is determined to be high as shown in block 626 (e.g., as determined by the confidence level module 220), the method 600 may proceed by routing (e.g., by the processor 204) the data (e.g., data 212) to the prediction engine (e.g., prediction engine 218) for machine prediction, thereby bypassing the human analyzer device (e.g., human analyzer device 108), as shown in block 628 (e.g., via links 226 and 228). Accordingly, the human analyzer device may be reserved to identify other data in which the machine learning model has difficulty in identifying, as human visual systems generally still greatly exceeds machine performance.

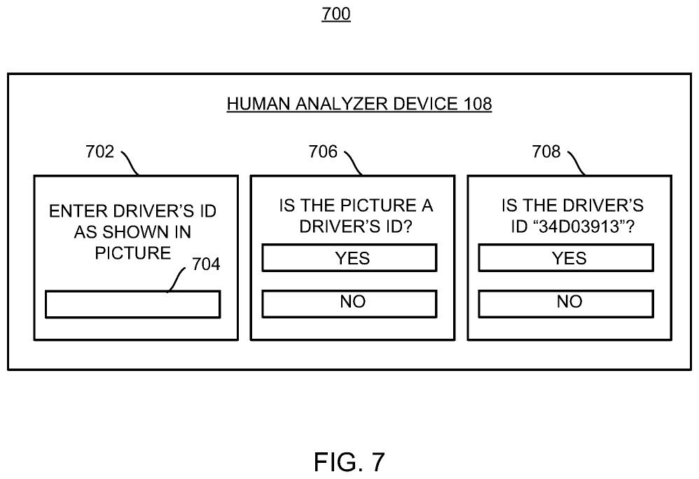

FIG. 7 illustrates an exemplary user interface 700 according to some embodiments. The user interface 700 may be integrated with the human analyzer device 108, or may be a distinct component communicatively coupled with the human analyzer device 108. As shown in FIG. 7, the user interface 700 may generate and/or display prompt 702 if the prediction confidence level is determined to be low. Accordingly, if a machine learning model 302 is not advanced enough to machine-identify data 212, a human analyzer may manually identify the data 212. For example, if a human analyzer device receives an image of a driver's license to identify a driver's ID, the human analyzer operating the human analyzer device may manually enter in the ID as shown in the image into the field 704.

Alternatively, the user interface 700 may generate and/or display prompts 706 or 708 if the prediction confidence level is determined to be average. Accordingly, if a machine learning model 302 is not yet advanced enough to bypass human identification, a human analyzer may manually identify the data 212. However, in contrast to when the prediction confidence level is determined to be low, the human analyzer may only have to select “YES” if the machine learning model 302 has already categorized the image as an image of a driver's license, or may only have to confirm “YES” if the machine learning model 302 has already identified the driver's ID. Accordingly, the human analyzer may not need to manually enter in the driver's ID, thereby allowing the human analyzer more time to identify other data that present greater identification challenges for the machine learning model 302. Accordingly, as the prediction confidence level increases, the prompt may be configured to request for less information from the human analyzer. If the human analyzer were to select “NO” in prompts 706 or 708, the human analyzer device may provide feedback to the processor 204 via links 114 and 226, which may then route the feedback to the machine learning model 302.

All of the foregoing methods discussed herein may be include additional, less, or alternate actions, including those discussed elsewhere herein. All of the foregoing methods may be implemented via one or more local or remote processors, transceivers, servers, and/or sensors, and/or via computer-executable instructions stored on computer-readable medium or media. The foregoing devices and systems may also include additional, less, or alternate functionality, including that discussed elsewhere herein.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein. Finally, unless a claim element is defined by reciting the word “means” and a function without the recital of any structure, it is not intended that the scope of any claim element be interpreted based upon the application of 35 U.S.C. § 112(f). The patent claims at the end of this patent application are not intended to be construed under 35 U.S.C. § 112(f) unless traditional means-plus-function language is expressly recited, such as “means for” or “step for” language being explicitly recited in the claim(s).

It is therefore intended that the foregoing detailed description be regarded as illustrative rather than limiting, and that it be understood that it is the following claims, including all equivalents, that are intended to define the spirit and scope of this invention.

1. A computer implemented method, carried out by one or more processors, for utilizing production data to enhance modifying of a machine learning model, the method comprising:
receiving production data from a client device;
determining a prediction confidence level associated with machine identification of the production data based on a machine learning model;
if the prediction confidence level is at a low level, routing the production data to a human analyzer device associated with a human analyzer;
if the prediction confidence level is at a high level, routing the production data to a prediction engine;
if the prediction confidence level is at an average level,
routing the production data to the human analyzer device to generate human-identified data and routing the production data to the prediction engine to generate machine-predicted data;
comparing the human-identified data and the machine-predicted data;
modifying the machine learning model using feedback associated with the comparison;
wherein the average level is higher than the low level and lower than the high level;
wherein the machine learning model is configured to be modifiable in response to feedback associated with at least one selected from a group consisting of the human analyzer device and the prediction engine; and
generating a prompt for the human analyzer device based on the prediction confidence level, wherein the prompt includes a manual entry by the human analyzer if the prediction confidence level is low and is configured to request for less information from the human analyzer as the prediction confidence level increases.

2. The method of claim 1, further comprising:
receiving, from the human analyzer device, identified data comprising the production data analyzed by the human analyzer; and
modifying the machine learning model using acquired feedback associated with the analysis of the identified data by the human analyzer.

3. The method of claim 2, further comprising transmitting the identified data to the client device.

4. The method of claim 1, further comprising:
receiving identified data comprising the production data analyzed by the human analyzer and the predicted data comprising the data analyzed by the prediction engine; and
comparing the predicted data with the identified data.

5. The method of claim 4, further comprising modifying the machine learning model using feedback associated with the comparing.

6. The method of claim 4, further comprising transmitting the predicted data to the client device.

7. The method of claim 1, wherein the routing of the production data to the prediction engine comprises bypassing the human analyzer device, if the prediction confidence level exceeds a predeterminable threshold.

8. (canceled)

9. A server for utilizing production data to enhance modifying of a machine learning model, the server comprising:
a memory configured to store computer executable instructions;
a processor configured to interface with the memory, wherein the processor is configured to execute the computer executable instructions to cause the processor to:
receive, via wireless communication or data transmission over one or more radio links or digital communication channels, production data from a client device;
determine a prediction confidence level associated with machine identification of the production data based on a machine learning model;
if the prediction confidence level is at a low level, route the production data to a human analyzer device associated with a human analyzer;
if the prediction confidence level is at a high level, route the production data to a prediction engine;
if the prediction confidence level is at an average level,
route the production data to the human analyzer device to generate human-identified data and routing the production data to the prediction engine to generate machine-predicted data;
compare the human-identified data and the machine-predicted data;
modify the machine learning model using feedback associated with the comparison;
wherein the average level is higher than the low level and lower than the high level; and
generate a prompt for the human analyzer device based on the prediction confidence level;
wherein the machine learning model is configured to be modifiable in response to feedback associated with at least one selected from a group consisting of the human analyzer device and the prediction engine;
wherein the prompt includes a manual entry by the human analyzer if the prediction confidence level is low and is configured to request for less information from the human analyzer as the prediction confidence level increases.

10. The server of claim 9, wherein the processor is further comprised to:
receive, from the human analyzer device, identified data comprising the production data analyzed by the human analyzer; and
modify the machine learning model using acquired feedback associated with the analysis of the identified data by the human analyzer.

11. The server of claim 10, further comprising:
a transceiver configured to interface with the processor and communicate via wireless communication or data transmission over one or more radio links or digital communication channels, wherein the transceiver is configured to transmit the identified data to the client device.

12. The server of claim 9, wherein the processor is further comprised to:
receive identified data comprising the data analyzed by the human analyzer and the predicted data comprising the production data analyzed by the prediction engine; and
compare the predicted data with the identified data.

13. The server of claim 12, wherein the processor is further comprised to modify the machine learning model using feedback associated with the comparing of the predicted data with the identified data.

14. The server of claim 12, further comprising:
a transceiver configured to interface with the processor and communicate via wireless communication or data transmission over one or more radio links or digital communication channels, wherein the transceiver is configured to transmit the predicted data to the client device.

15. The server of claim 9, wherein the routing of the data to the prediction engine comprises bypassing the human analyzer device, if the prediction confidence level exceeds a predeterminable threshold.

16. (canceled)

17. A non-transitory computer readable medium containing a set of computer readable instructions for utilizing production data to enhance modifying of a machine learning model, that when executed by a processor, cause the processor to:
receive, via wireless communication or data transmission over one or more radio links or digital communication channels, production data from a client device;
determine a prediction confidence level associated with machine identification of the production data based on a machine learning model; and
if the prediction confidence level is at a low level, route the production data to a human analyzer device associated with a human analyzer;
if the prediction confidence level is at a high level, route the production data to a prediction engine;
if the prediction confidence level is at an average level,
route the production data to the human analyzer device to generate human-identified data and the prediction engine to generate machine-predicted data;
compare the human-identified data and the machine-predicted data;
modify the machine learning model using feedback associated with the comparison;
wherein the average level is higher than the low level and lower than the high level;
generate a prompt for the human analyzer device based on the prediction confidence level;
wherein the machine learning model is configured to be modifiable in response to feedback associated with at least one selected from a group consisting of the human analyzer device and the prediction engine;
wherein the prompt includes a manual entry by the human analyzer if the prediction confidence level is low and is configured to request for less information from the human analyzer as the prediction confidence level increases.

18. The non-transitory computer readable medium of claim 17, wherein the processor is further comprised to:
receive, from the human analyzer device, identified data comprising the production data analyzed by the human analyzer; and
modify the machine learning model using acquired feedback associated with the analysis of the identified data by the human analyzer.

19. The non-transitory computer readable medium of claim 17, wherein the processor is further comprised to:
receive identified data comprising the production data analyzed by the human analyzer and the predicted data comprising the data analyzed by the prediction engine; and
compare the predicted data with the identified data.

20. The non-transitory computer readable medium of claim 19, wherein the processor is further comprised to modify the machine learning model using feedback associated with the comparing of the predicted data with the identified data.
